(19) United States
(12) Patent Application Publication
(10) Pub. No.: US 2007/0289427 A1
(43) Pub. Date: Dec. 20, 2007

(54) FOLDABLE GUITAR

(76) Inventor: Zemin Liang, Guangzhou (CN)

Correspondence Address: YING CHEN;Chen Yoshimura LLP, 255 S. GRAND AVE., # 215, LOS ANGELES, CA, 90012, US

(21) Appl. No.: 11/754,989

(22) Filed: May 29, 2007

(30) Foreign Application Priority Data
May 30, 2006 (CN) 200620059619.0
Dec. 30, 2006 (CN) 200620144607.8
Apr. 29, 2007 (CN) 200720050978.4

(51) Int. Cl. G10D 3/00

(52) U.S. Cl. 84/291

(57) ABSTRACT

A foldable guitar includes a soundbox, a bridge mounted on the soundbox, a neck, and strings extending between the bridge and the neck, where the neck and the soundbox are made of two pieces attached to each other in a foldable manner. In one embodiment, the neck and the soundbox are made of two pieces detachable from each other. In another embodiment, the neck and the soundbox are made of two pieces joined by a hinge and are capable of pivoting toward each other. In the assembled stated, the neck is securely mounted on the soundbox by a screw and but combination or other locking mechanism. The foldable guitar is compact and is easy to assemble and disassemble.

### BACKGROUND OF THE INVENTION

1. Field of the Invention

This invention relates to a string instrument such as a guitar, and in particular, it relates to a foldable guitar.

2. Description of the Related Art

In conventional guitars, the sound box and the neck are made as one rigid piece. As a result, guitars often have a long size, making it inconvenient to carry and prone to damage during transportation.

### SUMMARY OF THE INVENTION

Accordingly, the present invention is directed to a foldable guitar that substantially obviates one or more of the problems due to limitations and disadvantages of the related art.

An object of the present invention is to provide a foldable guitar in which the neck and soundbox can be folded with respect to each other.

Another object of the present invention is to provide a foldable guitar that has a simpler structure, can be quickly disassembled and assembled, and is convenient to use.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a foldable string instrument (e.g. a guitar), including a soundbox, a bridge mounted on the soundbox, a neck, and strings extending between the bridge and the neck, wherein the neck and the soundbox are made of two pieces and foldable with respect to each other. In the assembled (unfolded) stated, the neck is securely mounted on the soundbox by a screw and but combination or other locking mechanism.

In one embodiment, the neck and the soundbox of the foldable guitar are made of two pieces detachable from each other. In another embodiment, the neck and the soundbox are made of two pieces pivotally joined to each other.

It is to be understood that both the foregoing general description and the following detailed description are exemplary and explanatory and are intended to provide further explanation of the invention as claimed.

### BRIEF DESCRIPTION OF THE DRAWINGS

FIGS. 1 and 2 are front and side views of a foldable guitar according to a first embodiment of the present invention.

FIG. 3 illustrates the foldable guitar of the first embodiment in a disassembled state.

FIG. 4 is a partial cross-section view showing structures of the foldable guitar of the first embodiment.

FIGS. 5 and 6 are front and side views of a foldable guitar according to a second embodiment of the present invention.

FIGS. 7 and 8 are side and top views of the foldable guitar of the second embodiment in the folded state.

FIG. 9 is a side view of a foldable guitar according to a third embodiment of the present invention.

FIG. 10 is a partial cross-section view showing structures of the foldable guitar of the third embodiment.

### DETAILED DESCRIPTION OF THE PREFERRED EMBODIMENTS

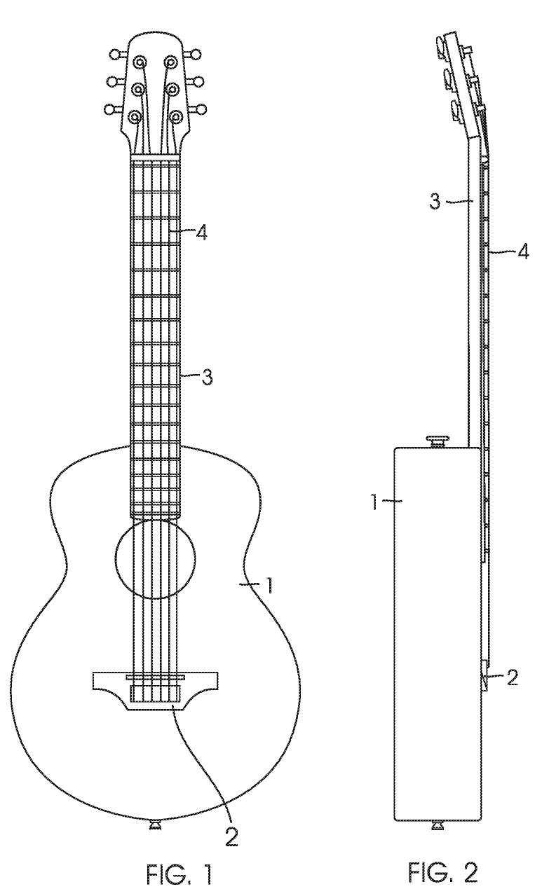

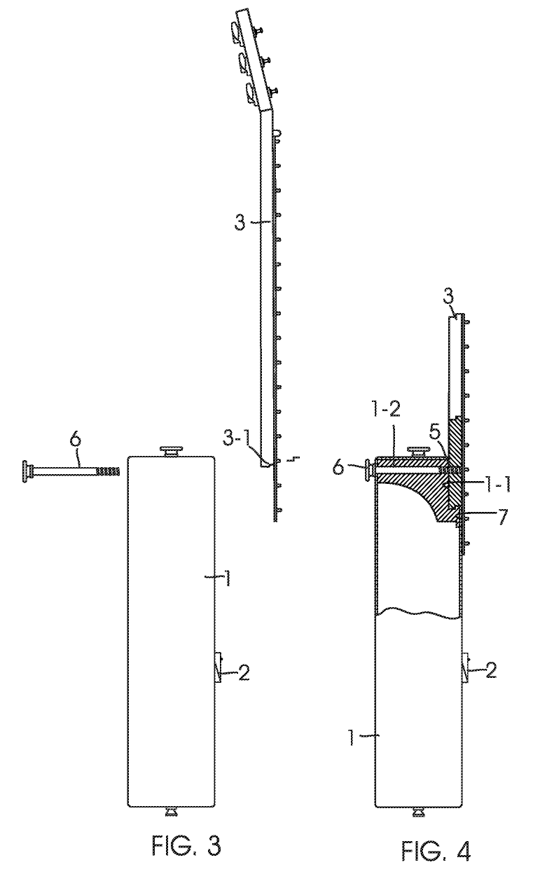

A foldable guitar according to a first embodiment of the present invention is described with reference to FIGS. 1 to 4. As shown in FIGS. 1-4, the foldable guitar includes a soundbox 1, a bridge 2, a neck 3, strings 4, a nut 5, a screw 6, and a locking protrusion 7. The bridge 2 is mounted on the soundbox 1, and the strings 4 extend between the bridge 2 and the neck 3. The neck 3 and the soundbox 1 are made of two pieces that can be joined together. A recessed portion 1-1 is formed near the top of the soundbox 1, and a through hole 1-2 is formed in the recessed portion 1-1 to the backside of the soundbox. The locking protrusion 7 is located at the lower end of the recessed portion 1-1 and protrudes over the recessed portion. The nut 5 is located at the lower end of the neck 3. In addition, the end portion of the neck 3 has a small locking recess 3-1 that corresponds to the locking protrusion 7. When the guitar is assembled (i.e. unfolded), the lower portion of the neck 3 is pushed into the recessed portion 1-1 such that the locking protrusion 7 fits in the locking recess 3-1. The screw 6 is inserted through the through hole 1-2 from the backside of the soundbox 1 and screwed into the nut 5. As a result, the neck 3 and the soundbox 1 are assembled into one unit and the guitar can be played. To disassemble (i.e. fold), such as when carrying or transporting the guitar, the screw 6 is unscrewed, and the neck 3 and the soundbox 1 are separated into two pieces (although the strings may still be attached to both pieces). This reduces the overall size of the guitar and makes it easier to carry or transport.

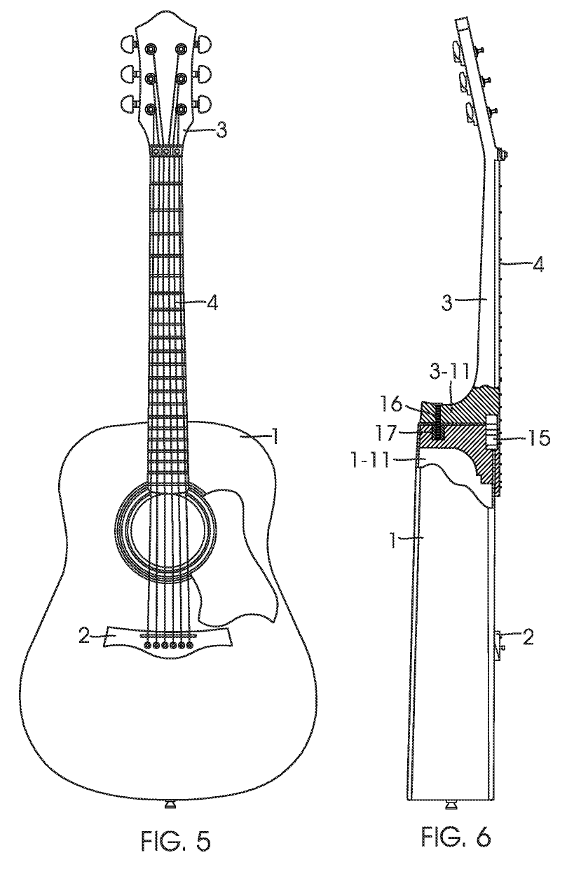

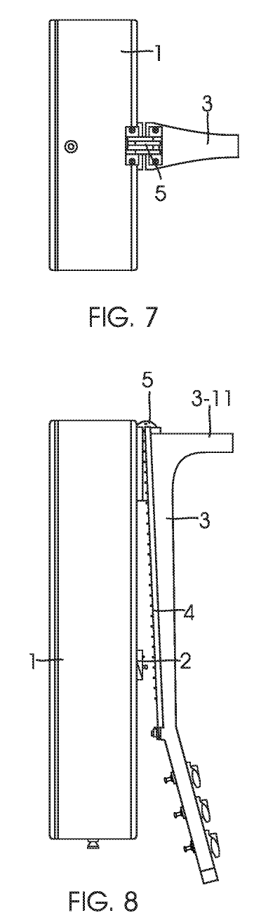

A foldable guitar according to a second embodiment of the present invention is described with reference to FIGS. 5 to 8. As shown in FIGS. 5-8, the foldable guitar includes a soundbox 1, a bridge 2, a neck 3, strings 4, one or more hinges 15, a screw 16 and a nut 17. The bridge 2 is mounted on the soundbox 1, and the strings extend between the bridge 2 and the neck 3. The neck 3 and the soundbox 1 are made of two pieces joined together by one or more hinges 15 located at the surfaces where the neck 3 and the soundbox 1 contact each other when assembled. The nut 17 is provided inside a top portion 1-11 of the soundbox 1, and the screw 16 passes through a portion 3-11 at the lower end of the neck 3 to engage the nut 17. As a result, the neck 3 and the soundbox 1 are assembled into one unit and the guitar can be played. To disassemble the guitar for carrying or transporting, the screw 16 is removed, so the portion 3-11 at the lower end of the neck 3 is disengaged from the top portion 1-11 of the soundbox. The neck 3 pivots around the hinge 15, and is folded toward the soundbox 1. This reduces the overall size of the guitar and makes it easier to carry or transport. To assemble the guitar for playing, the neck 3 is pivoted away from the soundbox 1, and the screw 16 is inserted and tightened to the nut 17 to secure the neck 3 to the soundbox 1.

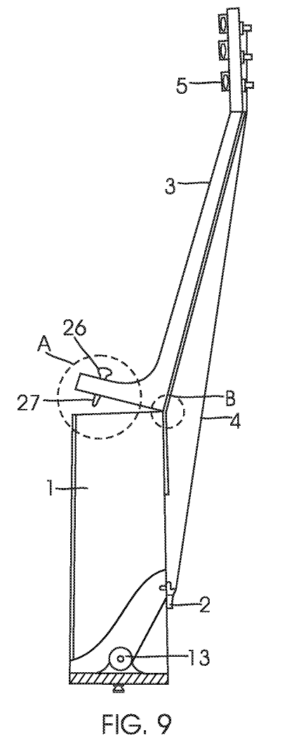

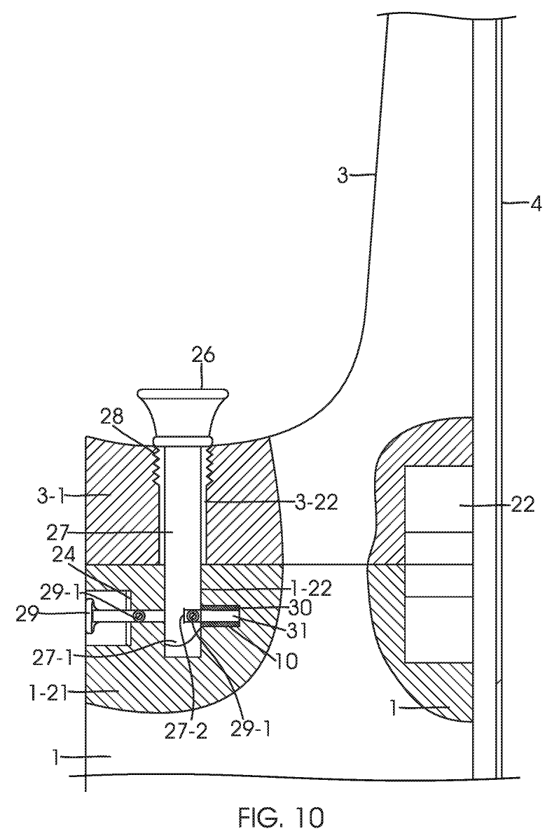

A foldable guitar according a third embodiment of the present invention is described with reference to FIGS. 9 and 10. As shown in FIGS. 9 and 10, the foldable guitar includes a soundbox 1, a bridge 2 mounted on the soundbox 1, a neck 3 formed of a separate piece from the soundbox, strings 4, a folding connection piece 22 (or a hinge) mounted on the neck 3 and the sound box 1 to allow the neck to pivot with respect to the sound box, and a locking mechanism to lock the neck to the soundbox when the guitar is in the unfolded state. The locking mechanism includes a bolt 27 with a groove 27-2 near the lower end, a head 26 at the upper end of the bolt 27, a sleeve 28, a pin 29, a locking spring 30, and a retaining plate 24 for retaining the pin 29. The lower portion 3-1 of the neck 3 has a through hole 3-22 corresponding in position to a hole 1-22 in an upper portion 1-21 of the soundbox 1 in the unfolded state. The sleeve 28 is located in the through hole 3-22. A channel 31 is formed in the upper portion 1-21 of the soundbox 1 and internally intersecting the hole 1-22. The pin 29 and the locking spring 30 are disposed within the channel 31. When the pin 29 is urged outward by the locking spring 30, a locking portion 29-1 of the pin 29 enters the groove 27-2 of the bolt to engage the bolt when the bolt is inserted into the hole 1-22. The retaining plate 24 fixes the position of the pin 29. When assembling the guitar, the bolt 27 is inserted through the sleeve 28 into the through hole 3-22 and the corresponding hole 1-22 in the soundbox 1. The lower end of the bolt 27 has a curved portion 27-1 that pushes the locking portion 29-1 of the pin (and hence the pin itself) further into the channel 31 until the groove 27-2 is aligned with the locking portion 29-1, at which point the locking portion 29-1 enters the groove 27-2 to lock the bolt 27. As a result, the neck 3 and the soundbox 1 are assembled into one unit and the guitar can be played. When disassembling the guitar for carrying or transporting, the pin 29 is pushed into the channel 31 against the spring 30 so that the locking portion 29-1 is outside of the groove 27-2 of the bolt, and the bolt 27 is removed by pulling the head 26. The neck 3 pivots around the folding connection piece 22, and is folded toward the soundbox 1.

The guitar may further include an automatic winding device 13 (shown in FIG. 9 but not in FIGS. 1 and 5) that automatically winds the strings 4 when the guitar is folded. This protects the strings from damage during transport.

The term “foldable” is used to refer to the guitars in both the first and the second and third embodiments. “Foldable” refers to the fact that the spatial relationship between the neck and the soundbox is not rigidly and permanently fixed but can assume a folded state. In the second and third embodiments, the neck and the soundbox are pivotally joined to each other and foldable with respect to each other. In the first embodiment, the neck and the soundbox are detached (although the strings that are still attached to both pieces) and foldable with respect to each other. This allows the guitar to have a smaller overall size when folded. In the unfolded or assembled state, the neck is securely mounted on the soundbox.

An advantage of the foldable guitar described above is its simpler structure and ease of assembling and disassembling. In the second and third embodiments, because the neck and the soundbox are pivotally joined together, the design avoids completely separating the two pieces while still accomplishing the reduction in size. The foldable guitar also achieves good sound quality.

Although a foldable guitar is described here, the invention can be applied to other string instrument that has a sound box and a neck.

It will be apparent to those skilled in the art that various modification and variations can be made in the foldable guitar of the present invention without departing from the spirit or scope of the invention. For example, although a screw 6 and a nut 7 are shown, other suitable structures may be used to lock the neck to the soundbox when assembled. Thus, it is intended that the present invention cover modifications and variations that come within the scope of the appended claims and their equivalents.

What is claimed is:

1. A foldable string instrument, comprising:
a soundbox;
a bridge mounted on the soundbox;
a neck; and
strings extending between the bridge and the neck,
wherein the neck and the soundbox are made of two pieces and foldable with respect to each other.

2. The foldable string instrument of claim 1, wherein the neck and the soundbox are pivotally joined to each other.

3. The foldable string instrument of claim 2, further comprising one or more hinges joining the soundbox and neck together.

4. The foldable string instrument of claim 2, further comprising a screw for securing a lower portion of the neck to a top portion of the soundbox when the string instrument is in an unfolded state.

5. The foldable string instrument of claim 4, further comprising a nut located inside a top portion of the soundbox for engaging the screw.

6. The foldable string instrument of claim 2, further comprising a folding connection piece pivotally joining the soundbox and neck together.

7. The foldable string instrument of claim 2, further comprising a locking mechanism for locking the neck to the soundbox when the string instrument is in an unfolded state, including:
a bolt having a curved lower end, a groove near the lower end, and a head at an upper end, the bolt being located in a through hole in a lower portion of the neck and a corresponding hole in an upper portion of the soundbox;
a pin located in a channel in the upper portion of the soundbox, the channel internally intersecting the hole in the upper portion of the soundbox, the pin having a locking portion adapted for entering the groove of the bolt; and
a spring disposed within the channel for urging the locking portion of the pin to enter the groove of the bolt.

8. The foldable string instrument of claim 1, wherein the neck and the soundbox are separable from each other.

9. The foldable string instrument of claim 8,
wherein the soundbox defines a recessed portion at a top end thereof and a through hole located in the recessed portion opening to a backside of the soundbox,
wherein the neck includes a nut near a lower end thereof,
wherein the guitar further comprises a screw, and
wherein in an assembled state, the lower end of the neck is located in the recessed portion of the soundbox, and the screw is inserted into the through hole to engage the nut on the neck, whereby the neck is assembled with the soundbox.

10. The foldable string instrument of claim 9,
wherein the soundbox further defines a locking protrusion at a lower end of the recessed portion,
wherein the lower end of the neck defines a locking recess, and
wherein in the assembled state, the locking protrusion of the soundbox fits in the locking recess of the neck.

11. The foldable string instrument of claim 1, further comprising an automatic winding device fir automatically winding the strings when the string instrument is folded.

12. A foldable string instrument, comprising:
a soundbox;
a bridge mounted on the soundbox;
a neck; and
strings extending between the bridge and the neck,
wherein the neck and the soundbox are made of two pieces pivotally attached to each other.
